(19) United States
(12) Patent Application Publication
(10) Pub. No.: US 2009/0078672 A1
(43) Pub. Date: Mar. 26, 2009

(54) Container and Preform for Obtaining a Container

(75) Inventors: Fiorenzo Parrinello, Medicina (IT); Matteo Camerani, Russi (IT)

Correspondence Address: NIXON & VANDERHYE, PC, 901 NORTH GLEBE ROAD, 11TH FLOOR, ARLINGTON, VA, 22203, US

(73) Assignee: SACMI COOPERATIVA MECCANICI IMOLA SOCIETA' COOPERATIVA, Imola (BO) (IT)

(21) Appl. No.: 12/085,433

(22) PCT Filed: Nov. 23, 2006
(86) PCT No.: PCT/IB2006/003330

§ 371 Date: Jul. 25, 2008

(30) Foreign Application Priority Data
Nov. 25, 2005 (IT) MO2005A000315

(51) Int. Cl. B65D 90/02; B29C 49/00

(52) U.S. Cl. 215/383; 425/532

(57) ABSTRACT

A container obtained from a compression-moulded preform (1; 31; 41; 51; 61; 71; 81; 91) comprises abase wall (203; 303) intended for being rested on a supporting surface and a side wall (202; 302) surrounding a main axis (X), the thickness (C4; P4) of said base wall (203; 303) measured near said main axis (X) being less than, or equal to 8.2 times the thickness (C1; P1) of said side wall (202; 302).

The invention relates to a container, particularly a bottle, obtained by means of a stretch blow-moulding or blow-moulding process from a compression-moulded preform.

The invention further relates to a compression-moulded preform, particularly for obtaining a container, for example a bottle, through stretch blow-moulding or blowing, with two-stage or one-stage technology.

The preforms for obtaining bottles normally comprise a hollow body of substantially cylindrical shape, having an end closed by a concave bottom wall. These preforms can be obtained through injection moulding, inside a mould comprising a punch that reproduces the internal shape of the preform and a die suitable for shaping the preform externally. The punch and the die are reciprocally movable between a closed position and an open position. In the closed position, between the punch and the die there is defined a forming chamber wherein the preform can be shaped, whilst in the open position the punch and the die are spaced apart from one another so that the preform can be extracted from the mould.

The die comprises an injection conduit through which, in the closed position, the plastics that are intended for constituting the preform are injected into the mould. The injection conduit leads into the moulding chamber at an injection point arranged in a central region of the concave bottom wall.

In order to obtain a preform, it is first necessary to arrange the punch and the die in the closed position. Subsequently, the plastics are introduced into the mould through the injection conduit until they fill the forming chamber completely. At this point, the injection of plastics is stopped and the preform is cooled inside the mould arranged in a closed position. When the preform has cooled sufficiently, the mould can be opened and the preform that has just been formed can be removed.

In the bottling industry the need is increasingly felt to reduce the quantity of plastics used for moulding a container, for example a bottle, having a preset capacity. For this purpose, the idea was devised of thinning the walls of the container, which requires starting from a preform of reduced thickness, particularly at the bottom wall.

Nevertheless, in the preforms obtained through injection moulding there exists a lower limit below which the thickness of the bottom wall cannot fall. In fact, in order to reduce the thickness of the bottom wall, it is necessary to reduce the distance between the punch and the die, in the closed position of the mould, near the injection point. By doing so, near the injection point a very narrow passage zone is defined that the plastics have to pass through to flow from the injection point to the zones of the forming chamber in which the hollow body of the preform will be formed. In the aforesaid passage zone, the plastics are subjected to a very high shear force, owing to which the molecules of the plastics tend to be orientated parallel to one another. In the preform, and in particular in the bottom wall thereof, undesired crystalline zones thus form that have the appearance of easily distinguishable opaque zones in the normally transparent preform. This phenomenon is commonly indicated by the expression “stress whitening”. Further, the crystalline zones may cause several drawbacks and in particular be origin zones from which breakages can be generated during the subsequent moulding of the bottle, or generate defects in the finished bottle that would compromise the aesthetic appearance and mechanical properties thereof.

For the reasons given above, the thickness of the bottom wall of the preforms that are injection-moulded and intended for forming containers by means of a two-stage stretch blow-moulding process cannot actually be less than 2 millimetres. Further, when the preform is blown to obtain the bottle, the central region of the bottom wall of the preform, arranged near the injection point, cannot be thinned below a certain limit. The central region of the bottom wall of the preform, if it is excessively thinned, could in fact break because of the great fragility thereof. For this reason, from the preforms that are injection-moulded, bottles are obtained having a base wall provided with a central zone of relatively great thickness.

An object of the invention is to improve existing containers and the preforms from which the containers are obtained. Another object is to decrease the quantity of plastics required for manufacturing a container having a preset capacity.

In a first aspect of the invention, there is provided a container obtained from a compression-moulded preform, said container comprising a base wall intended for being rested on a supporting surface and a side wall surrounding a main axis, characterised in that the thickness of said base wall measured near said main axis is less than, or equal to, 8.2 times the thickness of said side wall.

In a second aspect of the invention, there is provided a preform obtained through compression moulding, comprising a hollow body extending along a longitudinal axis and a bottom wall extending transversely to said longitudinal axis, characterised in that said bottom wall has a central region that is thinner than said hollow body.

In an embodiment, said central region has a thickness that is less than 2 millimetres.

In another embodiment, said central region has a thickness that is less than 1.5 millimetres.

Owing to these aspects of the invention, it is possible to obtain containers that, with the same capacity, enable material to be saved compared with the corresponding containers obtained from preforms that are injection-moulded. In fact, through compression-moulding it is possible to obtain preforms the bottom wall of which has a thickness profile that is much thinner than the thickness profile obtainable through injection moulding.

In particular, the bottom wall of the compression-moulded preforms may have a thickness of 1 mm, which is a value that is not obtainable in the preforms that are injection-moulded. This occurs because compression-moulding provides ways of introducing plastics into the mould intended to constitute the preform that are different from those provided in injection moulding.

Preforms can be further be obtained that have a bottom wall that is less stressed than the injection-moulded ones, which enables the bottom wall of the preform to be significantly thinned during moulding of the container. In this way, it is possible to form containers having a very thin base wall.

The invention can be better understood and implemented with reference to the attached drawings, which illustrate some embodiments thereof by way of non-limiting example, wherein:

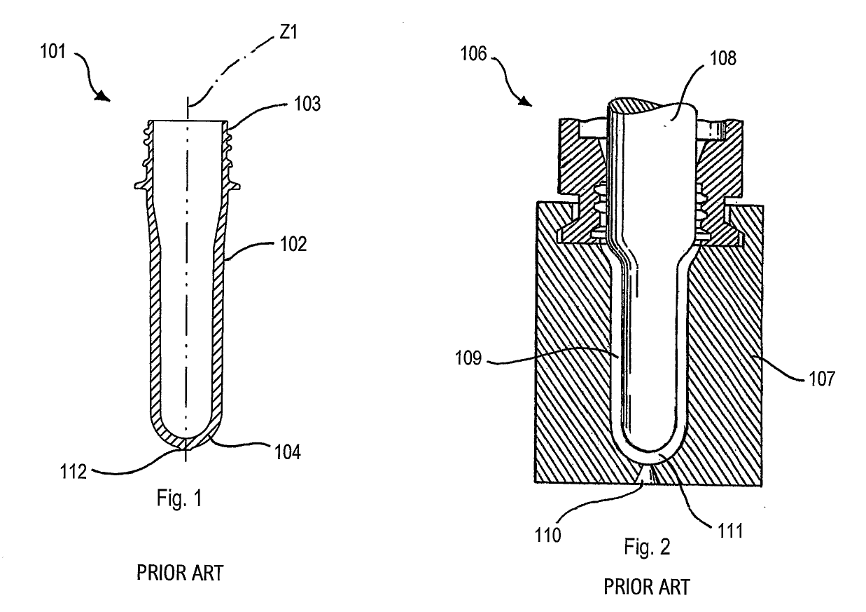

FIG. 1 is a section taken along a longitudinal plane of a preform according to the prior art;

FIG. 2 is a schematic section of a prior-art mould for forming the preform of FIG. 1 through injection moulding;

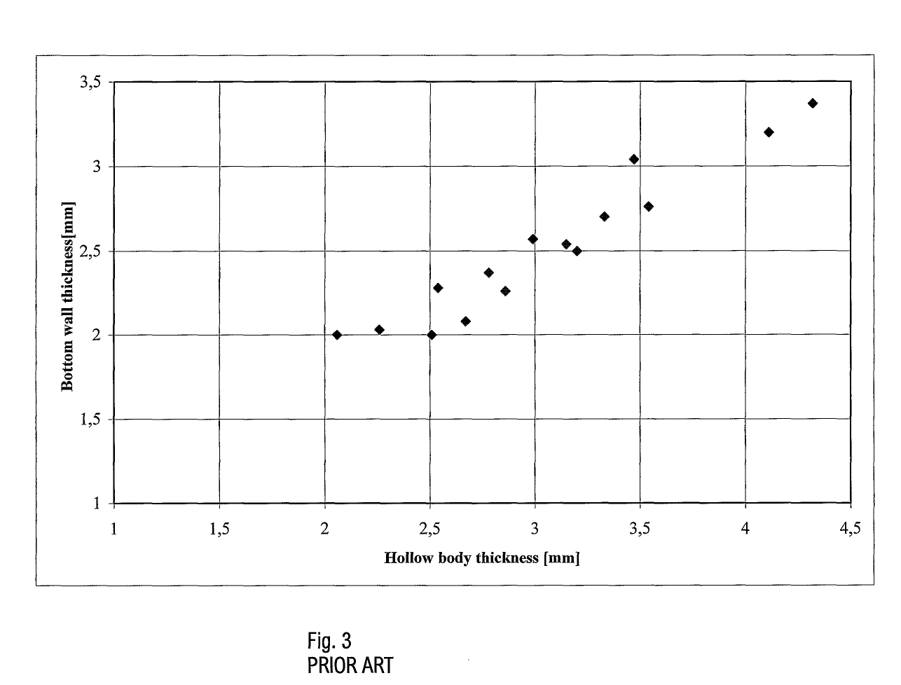

FIG. 3 is a graph that shows how the thickness varies in the preforms according to the prior art;

FIG. 4 is a schematic frontal view showing a first embodiment of a bottle according to the invention;

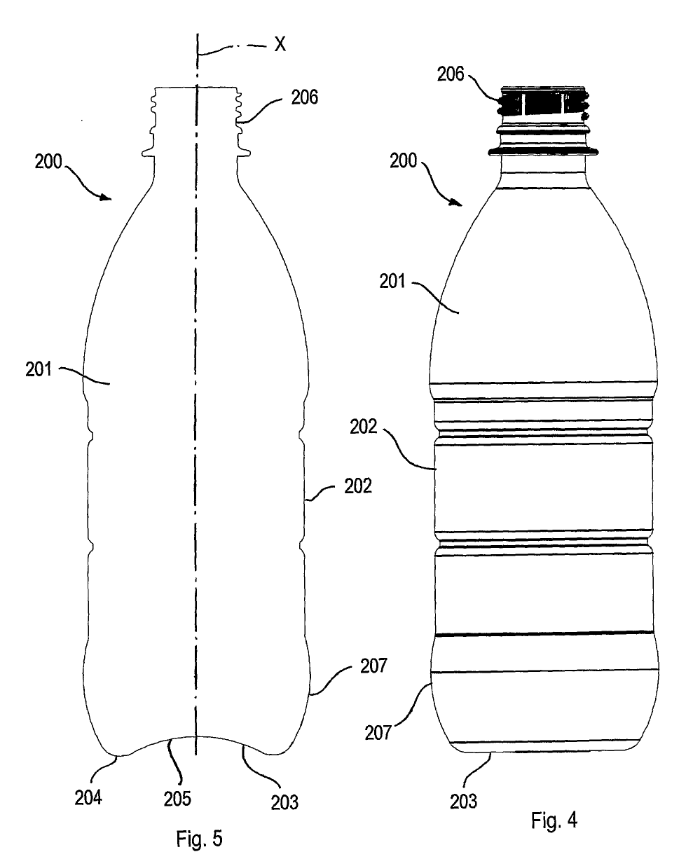

FIG. 5 is a section taken along a longitudinal plane of the bottle in FIG. 4;

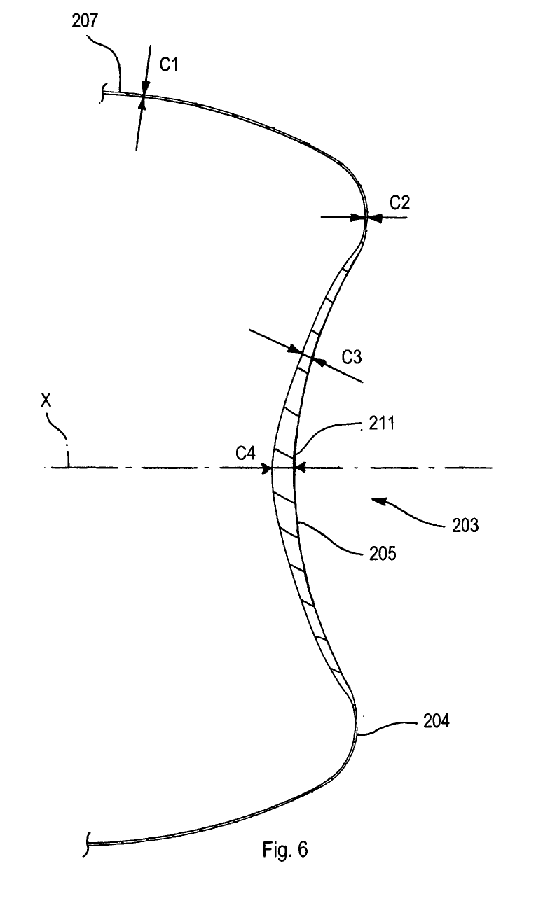

FIG. 6 is an enlarged and fragmentary cross section, showing a base wall of the bottle in FIG. 4;

FIG. 7 is a schematic front view showing a second embodiment of a bottle according to the invention;

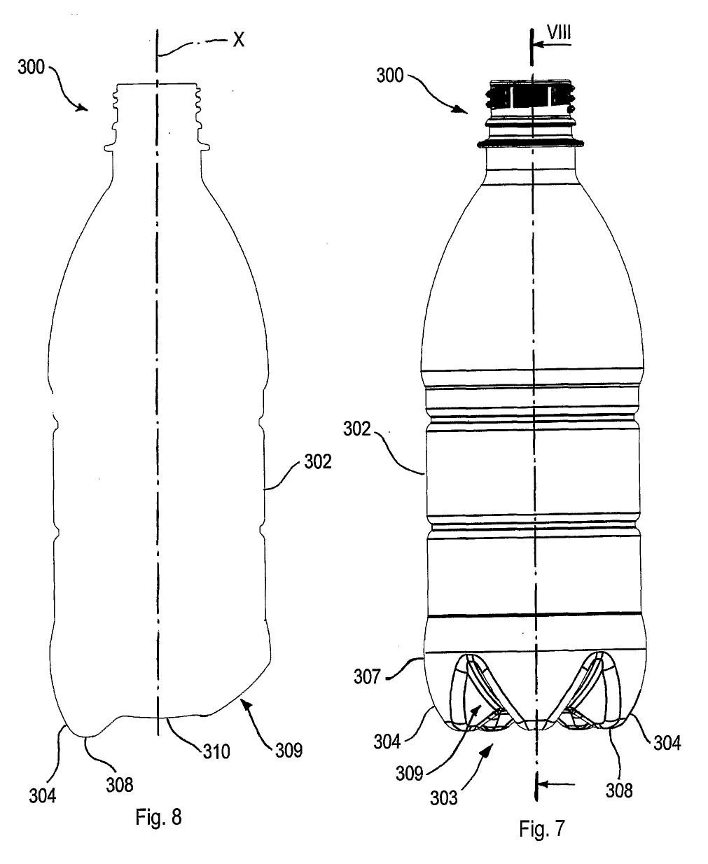

FIG. 8 is a schematic section taken along the plane VIII-VIII in FIG. 7;

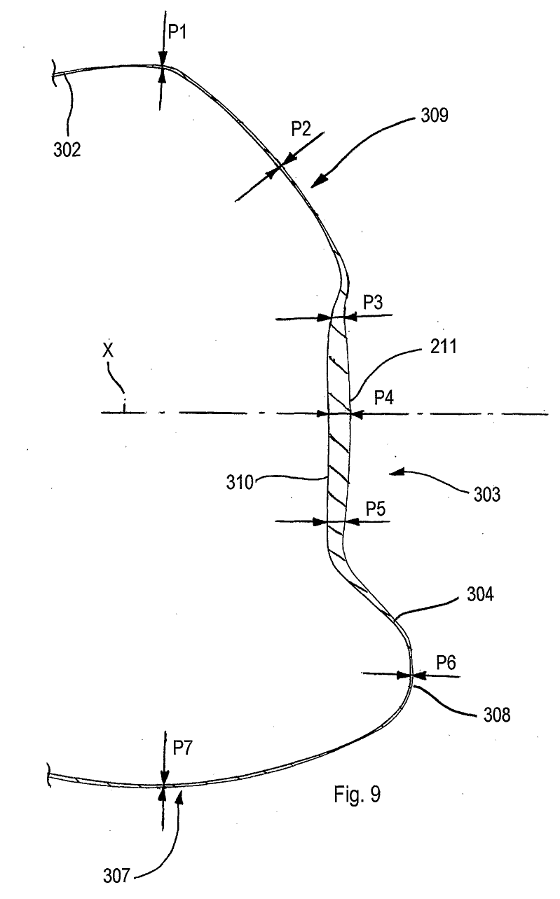

FIG. 9 is an enlarged and fragmentary cross section, showing a base wall of the bottle in FIG. 7;

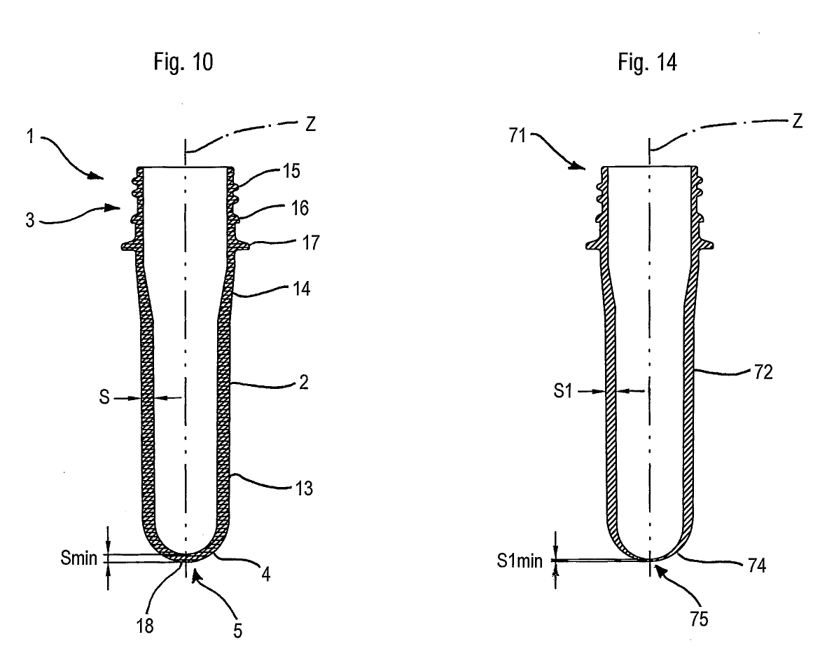

FIG. 10 is a section taken along a longitudinal plane of a preform for bottles;

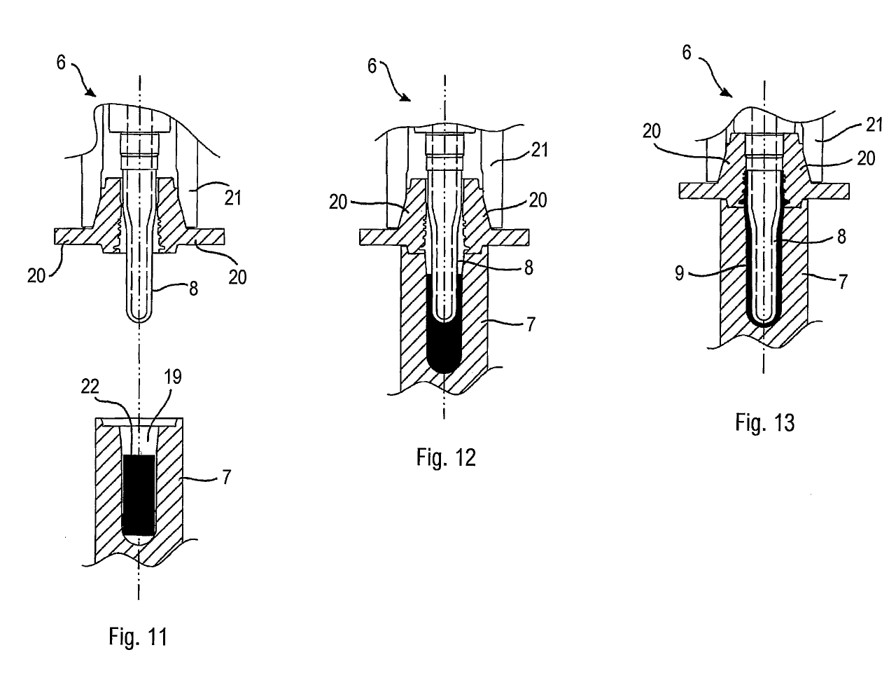

FIG. 11 is a schematic section of a mould for obtaining the preform in FIG. 10, in an open position;

FIG. 12 is a section like the one in FIG. 11, showing the mould in an intermediate position;

FIG. 13 is a section like the one in FIG. 11, showing the mould in a closed position;

FIGS. 14 to 20 are sections like the one in FIG. 10, showing alternative embodiments of the preform;

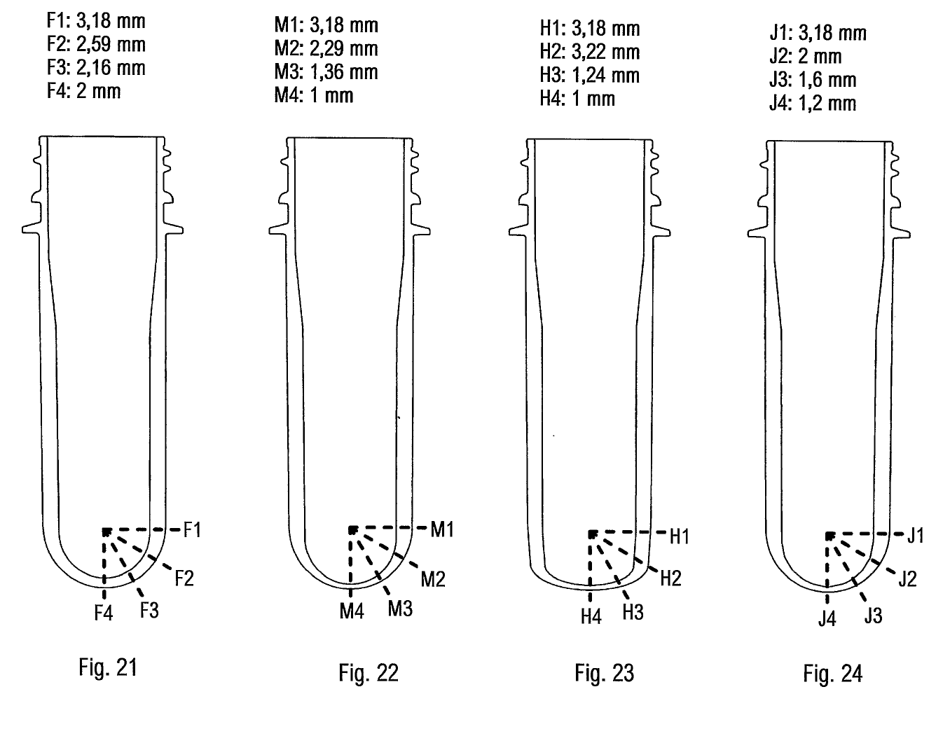

FIG. 21 is a section taken along a longitudinal plane of a preform according to the prior art, showing the thickness of the bottom wall in four special points;

FIGS. 22 to 24 are sections like the one in FIG. 21, referring to three embodiments of preforms according to the invention.

FIG. 1 shows a preform 101 according to the prior art, comprising a hollow body 102, of substantially cylindrical shape, that extends along a longitudinal axis Z1. The hollow body 102 is provided, at an end thereof, with a mouth 103, also called “finish”, that is suitable for engaging with a cap of a container. At a further end of the hollow body 102 opposite the mouth 103 there is provided a bottom wall 104 that extends transversely with respect to the longitudinal axis Z1 and is concave towards the inside of the preform 101.

The hollow body 102 has a thickness of 3.1 mm, whilst the bottom wall 104 has a thickness equal to approximately 80% of the thickness of the hollow body 102, i.e. approximately 2.5 mm.

The preform 101 was obtained through injection moulding, using a mould 106 of the type shown in FIG. 2. The mould 106 comprises a die 107, suitable for externally shaping the preform 101, and a punch 108, suitable for internally shaping the preform 101. The die 107 and the punch 108 are movable with respect to one another between a closed position, shown in FIG. 2, and an open position that is not shown. In the closed position, between the die 107 and the punch 108, there is defined a forming chamber 109 in which the preform 101 can be shaped. In the open position, the die 107 and the punch 108 are distanced from one another to enable the preform 101 that has just been formed to be extracted from the mould 106.

An injection conduit 110 is obtained in the die 107 and leads into the forming chamber 109 near a passage zone 111 intended for forming a central region of the bottom wall 104.

In order to obtain the preform 101, the die 107 and the punch 108 are positioned in the closed position and molten plastics are injected into the forming chamber 109 through the injection conduit 110. The molten plastics, passing through the passage zone 111, reach the zones of the forming chamber 109 wherein the hollow body 102 and the mouth 103 are formed until they fill the entire forming chamber 109. When the forming chamber 109 has been completely filled, the mould 106 remains in the closed position and is cooled so that the plastics that form the preform 101 start to solidify. Subsequently, the die 107 and the punch 108 reach the open position and the preform 101 is extracted from the mould 106.

The preforms 101 obtained through injection moulding are easily recognisable because on the external surface of the bottom wall 104 a sprue 112 is visible, at the zone into which the injection conduit 110 leads.

FIG. 3 is a graph wherein a plurality of points are shown, each of which refers to an injection-moulded preform that is normally available on the market. For each preform, on the x axis there is shown the thickness of the hollow body 102 and on the y axis there is shown the thickness of the bottom wall 104. In the right-hand part of the graph in FIG. 3, which refers to preforms having a thickness of the hollow body 102 greater than 2.5 mm, it should be noted that if the thickness of the hollow body 102 is reduced, also the thickness of the bottom wall 104 decreases. Between the thickness of the hollow body 102 and that of the bottom wall 104 an approximately linear relationship exists, inasmuch as the thickness of the bottom wall 104 is approximately equal to 80% of the thickness of the hollow body 102. In other words, in the right-hand part of the graphic in FIG. 3 the points relating to the preforms are arranged approximately along a rectilinear line tilted with respect to the x axis. Nevertheless, when the thickness of the hollow body 102 falls below 2.5 mm, the linear relationship disclosed above is no longer valid. In fact, as the three points furthest to the left of the graph in FIG. 3 confirm, the thickness of the bottom wall 104 of the preforms 101 obtained through injection moulding cannot fall below a minimum value of approximately 2 mm.

Thicknesses less than 2 mm cannot be obtained because they would entail a very narrow passage zone 111. The polymer chains of the plastics, as they are forced to pass through such a narrow passage zone 111, would be oriented parallel to one another and would form crystalline zones in the preform 101. The crystalline zones are not desired inasmuch as they constitute opaque zones that are visible to the naked eye that detract from the aesthetic appearance of the preform. Further, the crystalline zones may constitute start points from which breakage can start when the preform is processed to obtain therefrom a container such as a bottle and can decrease bottle performance.

As the preforms according to the prior art cannot be thinned at will, also the mass of the containers obtained therefrom cannot fall below a certain limit.

FIGS. 4 and 5 show a container according to the invention, particularly a bottle 200, comprising a containing body 201 defining a cavity suitable for receiving a content. The containing body 201 is bound by a side wall 202, that extends around a main axis X, and is closed at an end thereof by a base wall 203, arranged transversely to the main axis X. The base wall 203 comprises a annular resting portion 204 suitable for being rested on a supporting surface, for example of a table or of a shelf, and a convex portion 205 having the shape of a cupola that projects to the inside of the containing body 201. The annular resting portion 204 is continuous around the main axis X, i.e. it has a plan shape like that of a circular crown and surrounds the convex portion 205. Owing to the geometry of the base wall 203, the bottle 200 is called a “bottle with a champagne-type bottom”. This type of bottle is particularly suitable for containing liquids to which no carbon dioxide has been added, for example natural water, fruit juices, milk.

The side wall 202 comprises a connecting portion 207 along which the side wall 202 is joined to the base wall 203. At a further end opposite the base wall 203, the bottle 200 has a neck 206 comprising removable connecting means, for example a thread, by means of which a cap that is not shown can be removably fixed to the neck 206 to close the bottle 200.

The bottle 200 is made of plastics, for example polyethylene terephthalate (PET), polypropylene (PP), polyvinyl chloride (PVC), high-density polyethylene (HDPE) or polyethylene naphthalate (PEN). The bottle 200 is obtained by means of blowing or stretch-blowing of a compression-moulded preform, with one-stage or two-stage technology.

In the stretch-blowing process, a stretching rod is introduced inside a suitably heated preform so as to stretch the preform in a longitudinal direction thereof. Subsequently, or simultaneously, air is blown inside the preform, so that the latter can be radially widened until it assumes the shape of a mould inside which it is enclosed. In the blowing process, the preform becomes a container only through the action of the air blown inside the previously heated preform.

The two-stage technology provides moulding a preform, cooling it to ambient temperature and subsequently subjecting it to stretch-blowing or blowing to obtain a container therefrom. Between moulding of the preform and stretch-blowing or blowing of the container even several days may pass. Further, stretch-blowing or blowing of the container can be conducted by a person other than the person who moulded the preform, for example if the preforms are sold to a producer of containers.

On the other hand, in one-stage technology, between moulding of the preform and blowing or stretch-blowing thereof only a few seconds elapse. The preform is in fact extracted from the moulding machine and immediately blown or stretch blown to obtain the container, without being cooled to ambient temperature.

As shown in FIG. 6, the thickness of the base wall 203 is greatest near the main axis X and gradually decreases from the main axis X towards the annular resting portion 204. At the annular resting portion 204, the thickness of the base wall 203 reaches a minimum value that is also maintained along the connecting portion 207 of the side wall 202.

For example, the thickness C1 of the side wall 202 measured along the connecting portion 207 may be 0.22 mm. The thickness C4 of the base wall 203, measured at the main axis X and in the immediate vicinity thereof, may vary between 0.22 mm and 1.8 mm. Thus if the base wall 203 is thicker, the thickness C4 measured near the main axis X is approximately 8.2 times the thickness C1 of the side wall 202. If, on the other hand, the base wall 203 is thinner, the thickness C4 of the base wall 203 is substantially the same as the thickness C1 of the side wall 202.

Near the annular resting portion 204, the bottle 200 has a thickness C2 variable between 0.2 and 0.25 mm, i.e. almost the same as the thickness C1 of the side wall 202.

Lastly, in an intermediate position between the main axis X and the annular resting portion 204, the base wall 203 has a thickness C3 that is variable between 0.22 mm and 1 mm. In other words, the ratio between C3 and C1 varies between 1 and 4.5.

In an embodiment, the thickness of the bottle 200 may have the following values, included in the intervals disclosed above:
C1=0.22 mm
C2=0.2 mm
C3=0.5 mm
C4=0.7 mm

In this case, C4 is approximately equal to 3.2 times C1, whilst C3 is approximately equal to 2.3 times C1.

FIGS. 7 and 8 show a bottle 300 according to an alternative embodiment. The bottle 300 comprises a side wall 302 substantially similar to the side wall 202 of the bottle 200 shown in FIGS. 4 to 6, and a base wall 303 having a different shape from the previously described base wall 203, as will be explained below.

The base wall 303 comprises a plurality of protruding elements 304 that project outside the bottle 300, each protruding element 304 having a resting surface 308 intended for being rested on a supporting surface. Two adjacent protruding elements 304 are separated by a groove 309 directed along a radial plane containing the main axis X. The protruding elements 304 have a substantially triangular plan shape with vertices converging on a central zone 310 that may be substantially flat.

In the illustrated example, five protruding elements 308 are provided that are positioned symmetrically around the main axis X.

Owing to the geometry of the base wall 303, the bottle 300 is also said to have a “petal bottom”. A bottle of this type is suitable for containing liquids to which carbon dioxide has been added, for example fizzy mineral water or other fizzy drinks, inasmuch as the protruding elements 304 act as stiffeners that give the base wall 303 relatively high mechanical resistance.

As shown in FIG. 9, the base wall 303 has a maximum thickness near the main axis X. The thickness of the base wall 303 decreases gradually, but slowly, moving from the main axis X to the periphery of the central zone 310. Thus, moving from the central zone 310 to the supporting surfaces 308 along the respective protruding elements 304, the thickness of the bottom wall decreases gradually and in rather a rapid manner until it reaches a minimum value near the resting surfaces 308. This minimum value is approximately equal to the thickness measured along a connecting portion 307 along which the base wall 303 is joined to the side wall 302.

For example, the thickness P1 and P7 of the side wall 302 may be 0.4 mm.

Near the main axis X, the thickness P4 of the base wall 303 may vary between 0.4 mm and 2 mm. This means that when the base wall 303 is thicker, the thickness P4 thereof measured on the main axis X is five times the thickness of the side wall 302. When, on the other hand, the base wall 303 is thinner, the thickness P4 thereof measured on the main axis X is approximately equal to the thickness of the side wall 302.

In the resting surfaces 308, the base wall 303 has a thickness P6 that is variable between 0.35 mm and 0.45 mm, that may therefore be equal to, just greater than, or just less than, the thickness of the side wall 302.

Along the periphery of the central zone 310, near a protruding element 304, the thickness P5 of the base wall 303 is variable between 0.4 mm and 1.8 mm, i.e. may be at least equal to the thickness of the side wall 302 and at most equal to 0.45 times the thickness of the side wall 302. On the bottom of each groove 309, the base wall 303 has a thickness P2 that is variable between 0.4 and 0.5 mm, i.e. equal to, or slightly greater than, the thickness of the side wall 302.

Lastly, along the periphery of the central zone 310, near a groove 309, the bottle 300 has a thickness P3 that is variable between 0.4 mm and 1 mm, i.e. equal to, or up to 2.5 times greater than, the thickness of the side wall 302. In an embodiment, the thicknesses of the bottle 300 may have the following values, comprised in the intervals disclosed above:
P1=0.4 mm
P2=0.4 mm
P3=1 mm
P4=2 mm
P5=1.34 mm
P6=0.35 mm
P7=0.4 mm

The examples given above show that in the containers according to the invention it is possible to thin the base wall, not only at the points in which explicit reference is made, but along the entire extent of the wall. Further, at the base wall of the container according to the invention the thickness may vary according to a preset profile, and be decreased until it is made equal to the thickness of the side wall. This enables a significant quantity of plastics to be saved.

It should be noted that both the base wall 203 of the bottle 200 and the base wall 303 of the bottle 300 have a substantially smooth external surface 211, also near the main axis X.

This signifies that the bottles 200 and 300 have been obtained from respective compression-moulded preforms, because these bottles are devoid of the sprue that is typical of injection, moulding. Consequently, the base walls 203 and 303 do not have the drawbacks due to the injection-moulding process which are disclosed with reference to FIGS. 1 and 2. This ensures that the bottles 200 and 300, whilst having respective thinned base walls, retain good mechanical resistance.

FIG. 10 shows a preform 1 according to the invention, usable for obtaining a container such as, for example, a bottle by means of a process of stretch-blowing or blowing according to two-stage or one-stage technology. The preform 1 comprises a hollow body 2 that extends along a longitudinal axis Z. The hollow body 2 comprises a substantially cylindrical portion 13 and a slightly conical portion 14 arranged in sequence along the longitudinal axis Z. Near the slightly conical portion 14, the preform 1 is provided with a mouth 3 comprising a threaded portion 15, an annular projection 16 and a collar 17. The mouth 3 is also called a “finish” because it does not undergo substantial variations during the process by means of which the container is obtained from the preform 1. The mouth 3 is suitable for engaging, at the threaded portion 15, with a cap that closes the container.

At an end opposite the mouth 3, the hollow body 2 is closed by a bottom wall 4 that extends transversely to the longitudinal axis Z. The bottom wall 4 has the shape of a cupola, i.e. it is concave with a concavity facing inside the preform 1. The bottom wall 4 has a thickness that gradually decreases moving from the hollow body 2 towards the longitudinal axis Z. In the embodiment shown in FIG. 10, the hollow body 2 has, at the substantially cylindrical portion 13, a thickness S that may be approximately 3 mm. The thickness of the bottom wall 4 varies gradually from the value S to a minimum value Smin reached in a central region 5 arranged near the longitudinal axis Z. The minimum value Smin is less than 2 mm and, in particular, may be less than 1.8 mm.

The bottom wall 4 may have such a small thickness because the preform 1 is not obtained through injection moulding, but rather by compression moulding. This may be easily recognised because the bottom wall 4 is bounded by a substantially smooth external surface 18, also near the longitudinal axis Z. In other words, the bottom wall 4 does not have the sprue that can be seen in the preforms that are injection-moulded in the region into which the injection conduit leads.

FIGS. 11 to 13 show a mould 6 that may be used for forming the preform 1 in FIG. 10. The mould 6 comprises a die 7 provided with a cavity 19 in which the hollow body 2 and the bottom wall 4 can be shaped externally. The mould 6 further comprises a punch 8 for internally shaping the preform 1 and a pair of movable elements 20 for externally shaping the mouth 3. A sleeve 21 interacts with the movable elements 20 to keep them near one another.

As shown in FIG. 11, the mould 6 is initially in an open position, in which the die 7 is distanced from the punch 8, in such a way that it is possible to deposit in the cavity 19 a dose 22 of molten plastics, through a transferring device that is not shown. Subsequently, the die 7 is moved to the punch 8 and reaches an intermediate position, shown in FIG. 12, wherein the die 7 abuts against the movable elements 20. In this configuration, the punch 8 has already started to interact with the plastics constituting the dose 22. The die 7 continues to move towards the punch 8 together with the movable elements 20 until it reaches a closed position, shown in FIG. 13, in which between the die 7 and the punch 8 there is defined a forming chamber 9 having a shape substantially corresponding to the preform 1. The mould 6 remains in the closed position for a time that is sufficient for cooling the preform 1 through cooling means that is not shown, so as to stabilise the shape thereof. Subsequently, the mould 6 opens so that the preform 1 that has just been formed can be extracted and it is possible to start a new moulding cycle.

It should be noted that in compression moulding the bottom wall 4 is a zone of the preform 1 that is much less critical compared with what happens in injection moulding. In fact, in injection moulding all the plastics constituting the preform have to pass through the zone of the mould wherein the bottom wall is formed, and are subjected to very strong stress if the aforesaid zone is narrow. On the other hand, in compression moulding bottom wall 4 it is the last zone of the preform 1 that is shaped by the punch 8. Further, the plastics that constitute the bottom wall 4 are not subject to substantial movements during compression moulding of the preform 1, i.e. they do not have to flow to fill the forming chamber as on the other hand happens in injection moulding. For these reasons, in compression moulding, plastics that constitute the bottom wall 4 are not subject to particularly high stress. In the closed position the punch 8 can therefore be at a distance from the die 7 that is less than 2 mm without causing defects to the preform 1. This enables the bottom wall 4 of, the preform 1 to be thinned at will, compatibly with the resistance limits of the container obtained from the aforesaid preform.

By thinning the preform 1, it is possible to reduce the quantity of plastics necessary for manufacturing the container obtained from this preform, with the same container capacity.

For example, the thickness of the bottom wall may also be equal to three times the thickness of the walls of the container obtained from the preform.

In an embodiment that is not shown, the bottom wall of the preform may have a minimum thickness of 1 mm. This value is nevertheless not the minimum obtainable value. In fact, by using compression-moulding it is possible to obtain a preform 71 according to an alternative embodiment, shown in FIG. 14, having a similar shape to the preform 1 in FIG. 10, but provided with still more reduced thicknesses. In particular, the preform 71 comprises a hollow body 72 having a thickness S1 equal to 2.5 mm and a bottom wall 74, which, in a central region 75 thereof, has a minimum thickness S1 equal to 0.5 mm. The preform 71 enables a significant quantity of plastics to be saved and is particularly suitable for forming bottles intended to be filled with liquids such as natural water, milk or fruit juice that, being substantially devoid of dissolved gases, do not generate high pressures inside the bottle.

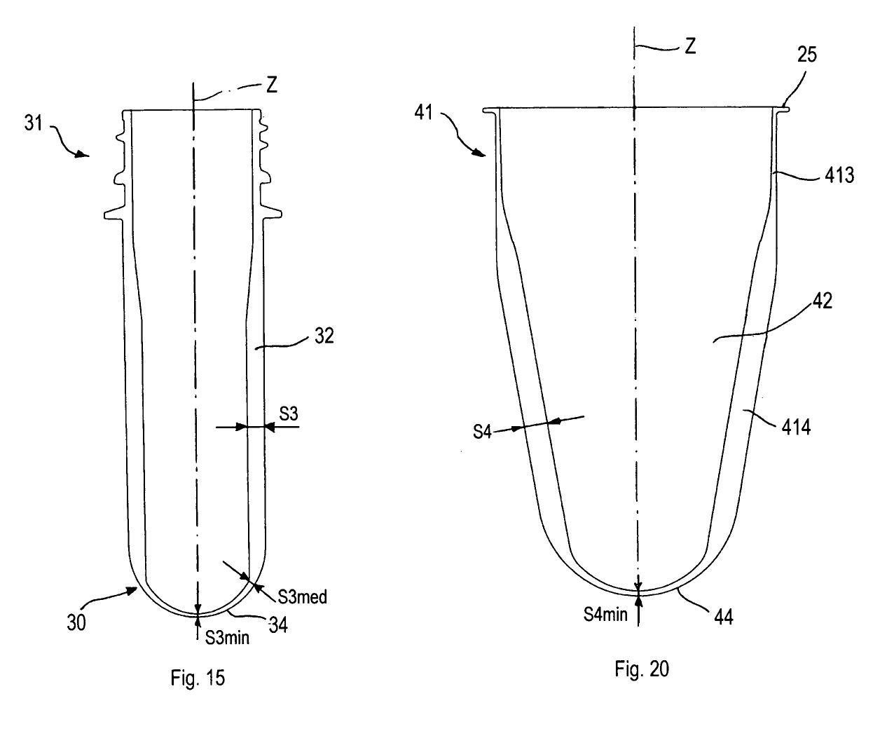

In the embodiments shown in FIGS. 10 and 14, the thickness of the preform gradually decreases moving from the hollow body to the longitudinal axis Z. Nevertheless, the thickness of the preform may also be decreased suddenly, as in the case in FIG. 15.

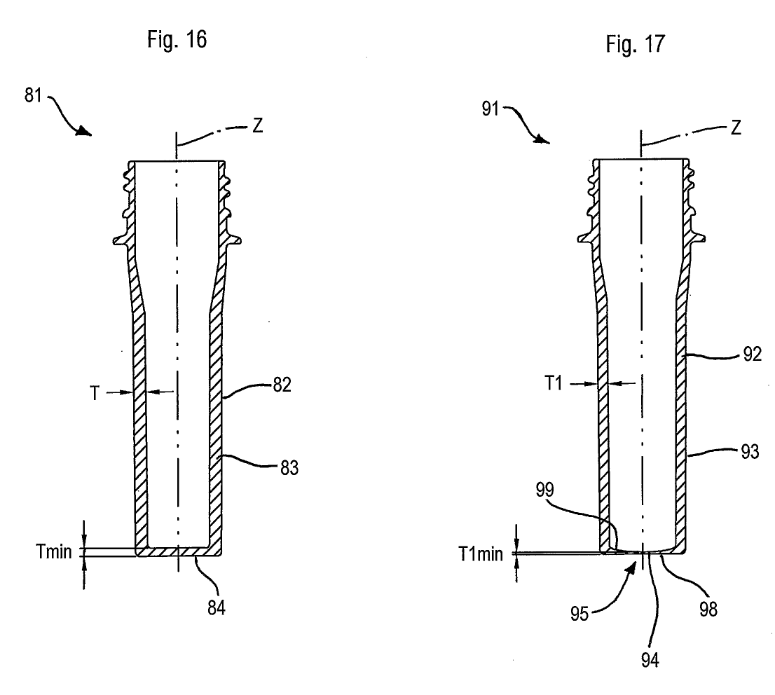

FIG. 15 shows a preform 31 obtained through compression moulding and comprising a hollow body 32 closed at an end thereof by a cupola-shaped bottom wall 34. The hollow body 32 has a substantially constant thickness S3. In a connecting zone 30 that connects the bottom wall 34 to the hollow body 32, the thickness of the preform 31 decreases drastically and becomes equal to a value S3med that may be a third or a quarter of S3. Moving towards the longitudinal axis Z, the thickness of the bottom wall 34 decreases further in a gradual manner until it reaches a minimum value S3min, that is less than 2 mm, near the longitudinal axis Z. In a further alternative embodiment, shown in FIG. 16, there is provided a preform 81 having dimensions similar to the preform 1 shown in FIG. 10, but comprising a substantially flat bottom wall 84. Also the preform 81 is obtained through compression-moulding. The bottom wall 84 may have a substantially constant thickness equal to a minimum value Tmin that is less than 2 mm. The preform 81 further comprises a hollow body 82 having a substantially constant cross-section portion 83. For example, the portion 83 may take the shape of a hollow cylinder, or of a regular prism with three, four, five, six or more faces. The portion 83 has a thickness T greater than the minimum value Tmin, for example equal to approximately 3 mm.

The FIG. 17 shows a preform 91 according to a still further alternative embodiment, obtained through compression-moulding. The preform 91 is similar to that shown in FIG. 16, but comprises a hollow body 92 and a bottom wall 94 that are thinner than those shown in FIG. 16. In particular, the hollow body 92 comprises a portion 93 having a substantially constant cross section having a thickness T1 that may be equal to 2.5 mm. The bottom wall 94 is bounded by a substantially flat external surface 98, and by a slightly concave internal surface 99 with concavity facing the inside of the preform 91. Near a central region 95 thereof, the bottom wall 94 has a minimum thickness T1min of approximately 0.5 mm. As previously explained with reference to FIG. 14, also the preform 91 is suitable for forming bottles intended to contain liquids substantially devoid of dissolved gases, and in particular of carbon dioxide. No extremely elevated mechanical resistance is in fact required of these bottles, it being possible to assure such mechanical resistance also with thicknesses less than traditional thicknesses.

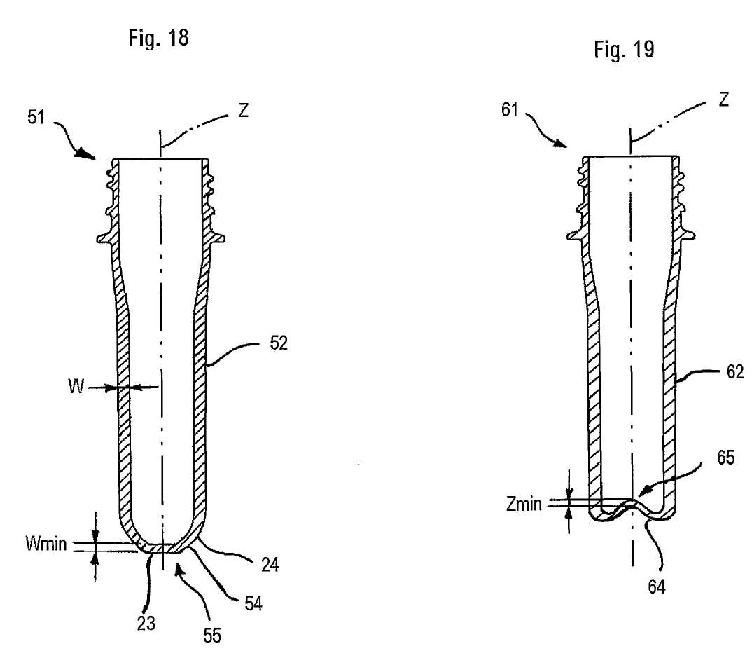

FIG. 18 shows a preform 51 according to another alternative embodiment, which is also obtained by compression moulding land comprising a hollow body 52 and a bottom wall 54. The preform 51 differs from the previously disclosed preforms in the shape of the bottom wall 54. The bottom wall 54 in fact comprises, in a central region 55 thereof, a flat portion 23 that extends transversely, in particular perpendicularly, to the longitudinal axis Z. The bottom wall 54 further comprises a curved portion 24, that extends around the flat portion 23 and connects it to the hollow body 52. The flat portion 23 has a substantially constant thickness Wmin, which may be less than a further thickness W of the hollow body 52. In particular, the thickness Wmin may be less than 2 mm.

When the preform 51 is stretch-blown for obtaining a bottle, the flat portion 23 remains substantially unaltered, whilst the curved portion 24 is deformed so as to form a resting zone of the bottle.

The FIG. 19 shows a preform 61 according to still another alternative embodiment, comprising a hollow body 62 and a bottom wall 64 that projects inside the hollow body 62. The bottom wall 64 in fact has a convex shape and is provided with a convexity that faces inside the hollow body 62. The bottom wall 64 may be thinner than the hollow body 62. In particular, in at least a central region 65 thereof, the bottom wall 64 may have a minimum thickness Zmin that is less than 2 mm. The bottom wall 64 may have a substantially constant thickness, equal to the value Zmin, in all the extent thereof, or may have a thickness that decreases gradually moving from the hollow body 62 to the longitudinal axis Z, until the value Zmin is reached in the central region 65.

The previously disclosed, preforms enable bottles to be obtained having very different shapes from the respective base walls. In particular, by using preforms of the type disclosed above, bottles can be obtained also with base walls that are different from those shown in FIGS. 4 to 9. By suitably selecting the shape of the bottom wall of the preform, it is possible to obtain a container comprising a base wall that may have any substantially desired geometry. FIG. 20 shows a compression-moulded preform 41 according to another alternative embodiment. The preform 41 comprises a hollow body 42 having an open end bounded by a flanged edge 25 substantially perpendicular to the longitudinal axis Z. The hollow body 42 further comprises a relatively thin substantially cylindrical portion 413, arranged in a position adjacent to the flanged edge 25 and a conical portion 414 interposed between the substantially cylindrical portion 413 and a bottom wall 44. The bottom wall 44 is shaped like a cupola and has a substantially uniform thickness S4min that is much less than the thickness S4 of the conical portion 414. For example S4min, which is less than 2 mm, may be a quarter or a fifth of S4.

The preform 41 may be used to form containers having a relatively wide mouth, for example tubs or yoghurt cups.

It is clear from the above that the bottom wall of the compression-moulded preforms may have a small thickness as desired, that is variable according to any law, in such a way as to make any desired shape of container.

FIGS. 22 to 24 show some example of preforms according to the invention, wherein variation in thickness of the bottom wall is disclosed by measuring the thickness at four typical points of the bottom wall. FIG. 21 refers to an injection-moulded preform.

The four typical points are indicated by a letter, which varies according to the type of preform considered, followed by a number that refers to the position of the point. In particular, number 4 refers to the thickness measured at the longitudinal axis of the preform. Number 3 refers to the thickness of the bottom wall measured along a plane that forms an angle of 30° with respect to the plane containing the longitudinal axis. Number 2 refers to the thickness of the bottom wall measured along a plane that forms an angle of 60° with respect to the plane containing the longitudinal axis. Lastly, number 1 refers to the thickness of the hollow body of the preform.

Comparing the injection-moulded preform shown in FIG. 21 with the compression,-moulded preform shown in FIG. 22, shows that it is possible to decrease the weight of the preform and thus consumption of plastics. In fact, whilst the preform shown in FIG. 21 weighs 2.5 grams, the preform shown in FIG. 22, which enables a container to be obtained that is substantially similar to that obtainable from the injection-moulded preform, weighs only 2 grams.

Also the preforms shown in FIGS. 23 and 24 enable a weight reduction to be obtained with respect to preforms that are injection-moulded to form similar containers, owing to the thickness profile selected for the bottom wall.

In this way it is possible to reduce also the weight of the corresponding containers.

1-39. (canceled)

40. Container obtained from a compression-moulded preform, said container comprising a base wall intended for being rested on a supporting surface and a side wall surrounding a main axis, the thickness of said base wall measured near said main axis being less than, or equal to, 8.2 times the thickness of said side wall, wherein the thickness of said base wall measured near said main axis varies between 0.4 mm and 1.8 mm.

41. Container according to claim 40, wherein the thickness of said base wall measured near said main axis is greater than, or equal to, the thickness of said side wall.

42. Container according to claim 40, wherein the thickness of said base wall decreases gradually from said main axis to a resting zone of said base wall suitable for being rested on said supporting surface.

43. Container according to claim 42, wherein, near said resting zone, said base wall has a thickness substantially equal to the thickness of said side wall.

44. Container according to claim 42, wherein said resting zone comprises a substantially continuous annular portion, said annular portion surrounding a convex portion projecting inside said container.

45. Container according to claim 44, wherein, in an intermediate region interposed between said main axis and said annular portion, the thickness of said base wall is less than, or equal to, 4.5 times the thickness of said side wall.

46. Container according to claim 45, wherein, in said intermediate region, the thickness of said base wall is greater than, or equal to, the thickness of said side wall.

47. Container according to claim 45, wherein, in said intermediate region, the thickness of said base wall varies between 0.22 mm and 4.5 mm.

48. Container according to claim 42, wherein said resting zone comprises a plurality of resting surfaces obtained on respective protruding elements, two adjacent protruding elements being separated by a corresponding groove extending radially with respect to said main axis.

49. Container according to claim 48, wherein the thickness of said base wall near said main axis is less than, or equal to, 5 times the thickness of said side wall.

50. Container according to claim 48, wherein said base wall comprises a central zone surrounded by said protruding elements, the thickness of said central zone near a protruding element being less than, or equal to 0.45 times the thickness of said side wall.

51. Container according to claim 50, wherein the thickness of said central zone near a protruding element varies between 0.4 mm and 1.8 mm.

52. Container according to claim 50, wherein the thickness of said central zone near a groove is less than, or equal to, 2.5 times the thickness of said side wall.

53. Container according to claim 52, wherein the thickness of said central zone near a groove varies between 0.4 mm and 1 mm.

54. Container according to claim 50, wherein the thickness of said central zone is greater than, or equal to, the thickness of said side wall.

55. Container according to claim 40, wherein the thickness of said side wall is measured in a connecting portion along which said side wall is joined to said base wall.

56. Container according to claim 40, obtained from said preform through stretch blow-moulding.

57. Container according to claim 40, obtained from said preform by means of blowing.

58. Container according to claim 40, obtained from said preform through a two-stage moulding technology.

59. Container according to claim 40, obtained from said preform through a one-stage moulding technology.

60. Container according to claim 40, wherein said base wall is bounded by a substantially smooth external surface.

61. Container according to claim 40, and having the shape of a bottle.

62. Preform obtained through compression moulding, comprising a hollow body extending along a longitudinal axis and a bottom wall extending transversely to said longitudinal axis, said bottom wall having a central region that is thinner than said hollow body, wherein said central region has a thickness that is less than 2 mm.

63. Preform according to claim 62, wherein said central region has a thickness that is less than 1.8 mm.

64. Preform according to claim 63, wherein said central region has a thickness of approximately 1 mm.

65. Preform according to claim 63, wherein said central region has a thickness of approximately 0.5 mm.

66. Preform according to claim 62, wherein said bottom wall becomes progressively thinner moving from said hollow body to said longitudinal axis.

67. Preform according to claim 62, wherein said central region has a substantially constant thickness.

68. Preform according to claim 67, wherein said bottom wall has a substantially constant thickness.

69. Preform according to claim 62, wherein said bottom wall has a concave shape with a concavity facing the inside of said hollow body.

70. Preform according to claim 62, wherein said bottom wall has a convex shape with a convexity facing the inside of said hollow body.

71. Preform according to claim 62, wherein said central region has a substantially flat shape.

72. Preform according to claim 71, wherein said bottom wall has a substantially flat shape.

73. Preform according to claim 62, wherein said central region is bounded by a substantially smooth external surface.

74. Preform according to claim 62, wherein said hollow body has a hollow cylindrical shape.

75. Preform according to claim 62, wherein said hollow body has a hollow prismatic shape.

76. Preform according to claim 62, wherein said hollow body has a conical shape.

77. Preform according to claim 62, wherein said hollow body comprises, in a region thereof opposite said bottom wall, a mouth provided with a removable fixing arrangement suitable for engaging with a container cap.

78. Preform according to claim 62, having a temperature equal to ambient temperature.
